(19) United States
(12) Patent Application Publication
(10) Pub. No.: US 2008/0281892 A1
(43) Pub. Date: Nov. 13, 2008

(54) Method and Apparatus for Generating Pseudo Random Numbers

(76) Inventor: Erwin Hemming, Herne (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/575,710

(22) PCT Filed: Sep. 22, 2004
(86) PCT No.: PCT/IB04/03085

§ 371 Date: Aug. 29, 2007

(51) Int. Cl. G06F 7/58

(52) U.S. Cl. 708/252

(57) ABSTRACT

The present invention proposes a methodology implementable in form of a hardware or software module for generating a pseudo random number. The pseudo random number corresponds to a pseudo random sequence of bits, which form the pseudo random number. A plurality of m polynomials is provided. The polynomials are derived from an original polynomial, which defines a feedback function of a linear feedback shift register capable for generating the pseudo random number. The polynomials are functions of n bits, which serve as initial bits and seed bits, respectively. Then, the polynomials are applied on the initial bits for generating the pseudo random number, which comprises at least m bits resulting from the m polynomials. Due to the fact that the polynomials are independent from each other, i.e. the initial bits serve as input values to the polynomials, the polynomials can be applied substantially simultaneously or in any other sequence.

The present invention relates to the field of pseudo random numbers (PRN) and in particular to methods and apparatus for generating such pseudo random numbers (PRN) in an efficient manner.

A huge number of technical applications require pseudo random numbers (PRN). Typical applications are spreading codes in CDMA (code division multiple access) transceivers, pseudo random function for scrambling (data encryption), pseudo random number bit generators as known from conventional programming languages, pseudo random number bit generators for test pattern generation used in IC (integrated circuit) production testing, codes used in GPS (global positioning systems), signature test pattern generation, generic algorithm programs etc, just for the way of illustration.

One approach for generating truly random numbers is to measure some kind of continuous natural phenomena such as the noise power level in a radio frequency receiver. Such noise power level appears to be random because the power level at any instant in time depends on an undeterminable number of variables. Nevertheless, for most applications pseudo random numbers (PRN) are sufficient and are obtainable simpler. A set of values or elements that is statistically random over long periods (dependent on the specific application) but derived from a known starting point, i.e. follow predicable patterns, is designated as pseudo random number (PRN).

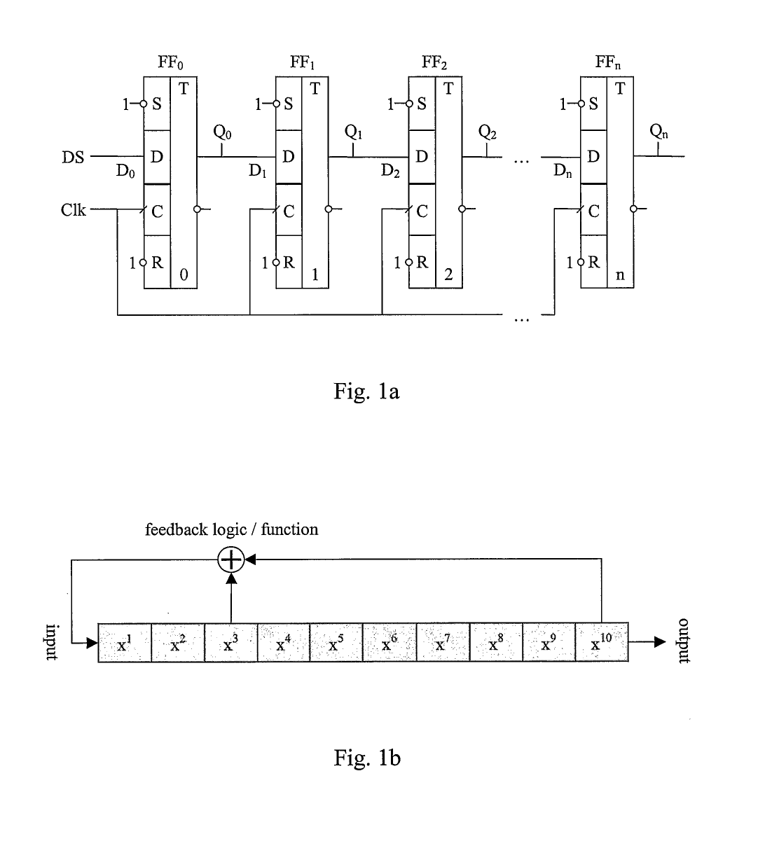

Several algorithms are known and applied for generating such pseudo random numbers. One conceptually simple way to generate long sequences of pseudo random numbers uses a linear feedback shift register (LFSR). Due to their simplicity linear feedback shift registers (LFSR) are widely applied, particularly for synchronizing sending and receiving devices in a spread spectrum transmission. FIG. 1a and FIG. 1b illustrate block diagrams showing an example circuit for implementing a shift register and a circuit diagram depicting an exemplary linear feedback mechanism for generating one or more pseudo random numbers.

The block diagram of FIG. 1a illustrates an example circuit composed of several flip-flops connected in series to realize a simple shift register. A flip-flop or bistable multivibrator is a pulsed digital circuit capable of serving as a one-bit memory used in electronics and computing. Typically, a flip-flop includes zero, one or two input terminals, a clock terminal, and an output terminal, even though commercial flip-flops additionally provide complement output terminal supplying the complementary output signal. Naturally, supplementary terminals required for operation of a flip-flop are included such as power supply terminal and ground terminal. By supplying a pulsing or strobing clock signal to the corresponding clock terminal, the flip-flop is caused to either change or retain its output signal being based upon the values of the input signals and the characteristic equation of the flip-flop. More precise, the wording strobing or pulsing clock signal is a simplified view. Any change of output state actually coincides with either the leading edge or the trailing edge of the clock pulse, and, to further complicate matters, may correspond to either a low-to-high or a high-to-low transition of the clock signal. Four types of flip-flops are commonly applied in clocked sequential systems, which are T (“toggle”) flip-flops, S-R (“set-reset”) flip-flops, J-K flip-flops, and D (“delay”) flip-flops. The behavior of the flip-flops is described by their specific characteristic equation, which is a function of the input signal(s) (e.g. R and S, or J and K, or D etc.) and the current output signal Q and which results in the next output signal Qₙₑₓₜ served by the output terminal after the next clock pulse.

In particular, the D (“delay”) flip-flop takes one input signal present at the input terminal D, which input signal the D flip-flop conveys as output signal at the output terminal Q when the clock is strobed. Regardless of the current value or state of the output, it will assume a value “1” if D=1 when the flip-flop is strobed or a value “0” if D=0 when the flip-flop is strobed. This D flip-flop can be interpreted as a primitive delay line or zero-order hold, since the data (a one-bit data information) is posted at the output one clock cycle after the data arrives at the input. The characteristic equation denotes as following:

Qₙₑₓₜ=D,

and the corresponding truth table is:

| D | Q | Qₙₑₓₜ |
|---|---|---|
| 0 | X | 0 |
| 1 | X | 1 |

The D flip-flop is suitable to realize registers to store numbers. Consequently, the shift register depicted in FIG. 1a for the way of illustration is composed of D flip-flops, wherein the first D flip-flop 0 is supplied with an input signal DS and the input terminal Dᵢ (i=0, . . . , n) of each succeeding D flip-flop FF₁ to FFₙ is connected to the output terminal Qᵢ (i=0, . . . , n) of the preceding D flip-flop FF₀ to FFₙ₋₁.

Those skilled in the art will appreciate that the circuit depicted in FIG. 1a enables a shift register being composed of a number of n registers, i.e. the D flip-flops FF₀ to FFₙ, set up in a linear fashion, which have their inputs and outputs connected together in such a way that the register element states are shifted with each clock pulse from the register elements/flip-flops having low numbers to the register elements/flip-flops having high numbers. Conventionally, shift registers may have a combination of serial and parallel inputs and outputs, including serial-in, parallel-out and parallel-in, serial-out types. There are also types of shift registers that have both serial and parallel input and types of shift registers with serial and parallel output. There are also bi-directional shift registers, which allow you to vary the shift direction of the shift register. The depicted shift register shows a serial input designated as DS and a serial output designates as Qₙ. A parallel output can be realized by taping the outputs Dᵢ (i=0, . . . , n).

Those skilled in the art will appreciate that the description of shift registers given above and the illustrated implementation of a shift register of the basis of D flip-flops is neither conclusive nor complete since the realization of shift registers is out of the scope of the present invention. However, the description stated above enables the skilled reader for understanding the concept of the invention provided in detail below. Firstly, a short introduction to feedback mechanism implementable on the basis of shift registers will be given complementary.

The block diagram of FIG. 1b illustrates a shift register with several register elements xⁱ, which shift register input is supplied with a feedback signal in accordance with a feedback logic/function. Each register element xⁱ or register element or register cell is realized exemplary by a flip-flop as aforementioned, whereas the designation xⁱ shall refer to an individual register element, the totality of which forms the shift register, and simultaneously represent a content variable of the individual register element, which is capable of storing a one-bit informational content, i.e. xⁱ=0 or xⁱ=1. This means, each register element of the shift register serves as a one-bit storage cell. For the way of illustration, the illustrated shift register includes ten register elements x¹ to x¹⁰; consequently, the shift register is capable of storing an informational content of 10 bits.

Upon each clock cycle, the content of the register element xⁱ is shifted to the succeeding register element xⁱ⁺¹, which carries the shifted content after completion of the clock cycle. This means, an output signal of the shift register is available at the shift register output, which corresponds to the content of the last register element x¹⁰. With each clock cycle the content of the last register element x¹⁰ is overwritten with the content of the last but one register element x⁹ provided at the shift register output. The input of the shift register is supplied with input signal caused by feedback function. The feedback function is supplied with signals resulting from two or more tapped register elements of the shift register. In an exemplary fashion, the outputs of the register elements x³ and x¹⁰ (i.e. the output signal currently provided at their output terminals) are tapped and supplied to the feedback function, which is herein for simplicity an exclusive-OR (OR) function combining the tapped content values x³ and x¹⁰. In general, the outputs that influence the input are called taps. The following truth table illustrates the results of the OR function:

| XOR | | |
|---|---|---|
| “⊕” | 0 | 1 |
| 0 | 0 | 1 |
| 1 | 1 | 0 |

Assuming that the shift register has initially a non-zero initial values and seed value, respectively, the shift register outputs a stream of output signals with each clock cycle, which forms a pseudo random number sequence of 1-bit values. The maximal periodicity of the outputted pseudo random number sequence is predefined by the number of different states of the shift register, which number is 2ⁿ−1, where n is the number of registers. Assuming again the number of 10 registers, the number of different states results to 2¹⁰−1=1023. The state, which is characterized by the register values each being equal zero, is stable and has to be prevented. In particular, the real periodicity, which is equal or smaller than the obtainable maximal periodicity depends on the taps supplied to the feedback function as well as the feedback function itself. In case of a linear feedback function as illustrated with reference to FIG. 1b, the periodicity can be determined by the means of mathematical methods.

The description above has been introduced into the field of shift registers and their specific application as pseudo random number generators by the use of linear feedback shift registers (LFSR) with adequate feedback functions. Nevertheless, those skilled in the art will appreciate immediately that the illustrated methodology implies various deficiencies. The skilled reader understands that the aforementioned algorithm for realizing pseudo random number generators on the basis of linear feedback shift registers (LFSR) represents a recursive algorithm. This means, upon each iteration of the algorithm or clock cycle only one (single) bit results from the shift register and is provided at its output. For generating a final pseudo random sequence of m bits the aforementioned algorithm requires m iterations and clock cycles, respectively.

Some applications require pseudo random numbers of numerous bits with high data rates for processing. To comply with such requirements, the clock cycle rate may be increased, which implies the implementation of adequate shift registers and flip-flops operating at such increased data rates, or alternatively deep combinatorial logic enabling of performing several iterations in a single clock cycle. Shift registers and flip-flops adapted to high data rates are expensive and deep combinatorial logic includes a reduction of the clock cycle rate due to long delays caused by the deep combinatorial logic.

It is now invented a methodology for generating pseudo random numbers on the basis of the aforementioned shift register feedback logic, which overcomes the deficiencies of the state of the art stated above. In particular, an embodiment of the present invention provides a methodology for generating pseudo random numbers at a high rate factor in comparison with the iterative methodology. More particularly, the inventive methodology allows a generation of the bits of pseudo random numbers in reverse order.

The objects of the present invention are solved by the subject matter defined in the accompanying independent claims.

According to a first aspect of the present invention, a method for generating a pseudo random number is provided. The pseudo random number corresponds to a pseudo random sequence of bits, which form the pseudo random number. A plurality of m polynomials is provided. The polynomials are derived from an original polynomial, which defines a feedback function of a linear feedback shift register capable for generating the pseudo random number. The polynomials are functions of n bits, which serve as initial bits and seed bits, respectively. Then, the polynomials are applied on the initial bits for generating the pseudo random number, which comprises at least m bits resulting from the m polynomials. Due to the fact that the polynomials are independent to each other, i.e. the initial bits serve as input values to the polynomials, the polynomials can be applied substantially simultaneously or in any other sequence.

According to an embodiment of the present invention, the plurality of m polynomials are derived from the original polynomial by stepwise defining the polynomials each representing a feedback function at a defined iteration and reducing the polynomials to obtain polynomials, which are functions of the initial bits.

According to another embodiment of the present invention, the polynomials are applied substantially simultaneously. Further, according to another embodiment of the present invention, the polynomials are applied in reverse order to generate firstly lower bits of the pseudo random number and subsequently higher bits of the pseudo random number.

According to yet another embodiment of the present invention, the polynomials represent logic relationships for combining at least two values each having a domain of one bit.

According to a further embodiment of the present invention, the m polynomials are static polynomials, i.e. the polynomials are (pre-)determined by the original polynomial defining the feedback function such that the polynomials can be provided fixedly for application. According to another embodiment of the present invention, the m polynomials are dynamic polynomials, i.e. the polynomials are derived from the provided original polynomials by reduction to the order of the original polynomial such that the polynomials are functions of the initial values. The dynamical provision of the polynomials allows for providing differing original polynomials as the basis for the generation of the sequence of pseudo random bits enabling the forming of a pseudo random number thereof.

According to yet a further embodiment of the present invention, the maximal number mₘₐₓ of the polynomials is less or equal to 2^{np}−(n+1). According to an additional embodiment of the present invention, an order of said polynomials is equal or less to np, where np represents an order of the original polynomial.

According to yet an additional embodiment of the present invention, the pseudo random number comprising the m bits resulting from the polynomials and the n initial bits is identical with a sequence obtained from the linear feedback shift register used as a pseudo random number generator and applying the feedback function corresponding to the original polynomial.

According to a second aspect of the present invention, a module for generating a pseudo random number is provided. The module comprises an initial storage having a number of n initial storage cells. Each initial storage cell serves as a one-bit storage. The module includes additionally a result storage having a number of m result storage cells. Each result storage cell serves also as a one-bit storage. A combinatorial logic of the module is selectively coupled to output terminals of said n initial storage cells and is selectively coupled to input terminals of said m result storage cells. The combinatorial logic implements a number of m polynomials, which are derived from an original polynomial defining a feedback function of a linear feedback shift register operable as a pseudo random number generator. The polynomials are functions of the n bits serving as initial bits and stored in the initial storage cells.

According to an embodiment of the present invention, the combinatorial logic is implemented as a software module, which comprises code sections. When executed on a processing unit, the code sections perform logical relationship operations in accordance with the combinatorial logic defined on the basis of the polynomials.

According to another embodiment of the present invention, the combinatorial logic is implemented by the means of a plurality of logic components. Each logical component has at least two input terminals for receiving one-bit inputs and each having at least one output terminal for providing a one-bit output. The output result is defined by the predefined combinatorial logic relationship.

According to a third aspect of the present invention, an electronic apparatus is provided, which comprises an initial storage, a result storage and a combinatorial logic. The initial storage has a number of n initial storage cells and the result storage has a number of m result storage cells. Each initial or result storage cell serves also as a one-bit storage. The combinatorial logic of the module is selectively coupled to output terminals of said n initial storage cells and is selectively coupled to input terminals of said m result storage cells. The combinatorial logic implements a number of m polynomials, which are derived from an original polynomial defining a feedback function of a linear feedback shift register operable as a pseudo random number generator. The polynomials are functions of the n bits serving as initial bits and stored in the initial storage cells.

According to a fourth aspect of the present invention, a system for generating a pseudo random number is provided. The system includes a number of n initial states representing n initial 1-bit values, and a number of m result states representing m result 1-bit values. A combinatorial logic being also comprised by the system is selectively supplied with said n initial states and supplies selectively said m result states. The combinatorial logic implements a number of in polynomials, which are derived from an original polynomial. The original polynomial defines a feedback function of a linear feedback shift register. The polynomials are functions of n 1-bit states, which states serve as initial states defining the initial values.

According to a fifth aspect of the present invention, a computer program product for generating a pseudo random number is provided, which comprises program code sections stored on a machine-readable medium for carrying out the steps of the method according to any aforementioned embodiment of the invention, when the computer program product is run on a processor-based device, a computer, a terminal, a network device, a mobile terminal, or a mobile communication enabled terminal.

According to a sixth aspect of the present invention, a computer program product for generating a pseudo random number is provided, comprising program code sections stored on a machine-readable medium for carrying out the steps of the aforementioned method according to an embodiment of the present invention, when the computer program product is run on a processor-based device, a computer, a terminal, a network device, a mobile terminal, or a mobile communication enabled terminal.

According to a seventh aspect of the present invention, a software tool is provided. The software tool comprises program portions for carrying out the operations of the aforementioned methods when the software tool is implemented in a computer program and/or executed.

According to an eighth aspect of the present invention, a computer data signal embodied in a carrier wave and representing instructions is provided which when executed by a processor causes the steps of the method according to an aforementioned embodiment of the invention to be carried out.

Advantages of the present invention will become apparent to the reader of the present invention when reading the detailed description referring to embodiments of the present invention, based on which the inventive concept is easily understandable.

The accompanying drawings are included to provide a further understanding of the invention, and are incorporated in and constitute a part of this specification. The drawings illustrate embodiments of the present invention and together with the description serve to explain the principles of the invention. In the drawings,

FIG. 1a shows a block diagram illustrating an example circuit composed of several flip-flops connected in series to realize a simple shift register;

FIG. 1b shows a block diagram illustrating a shift register with several registers xⁱ, which shift register input is supplied with linear feedback signal;

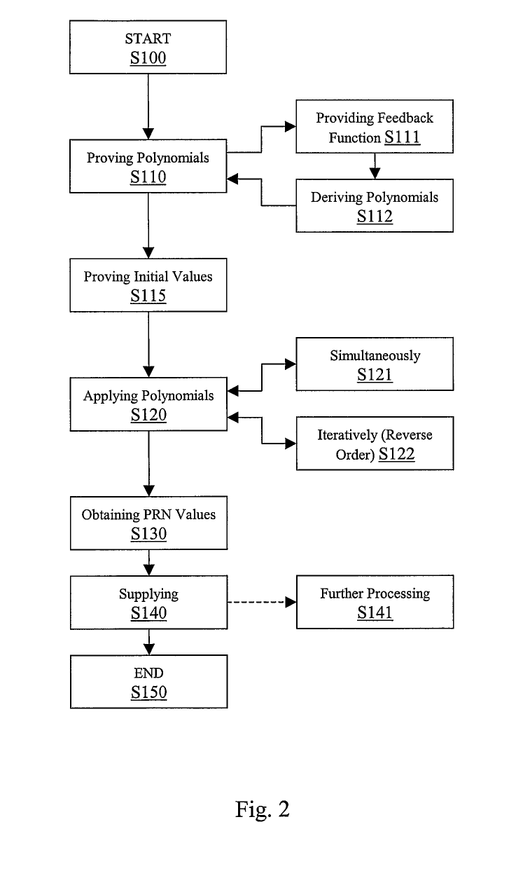

FIG. 2 illustrates a schematic sequence diagram enabling generation of random bits in accordance with embodiments of the present invention;

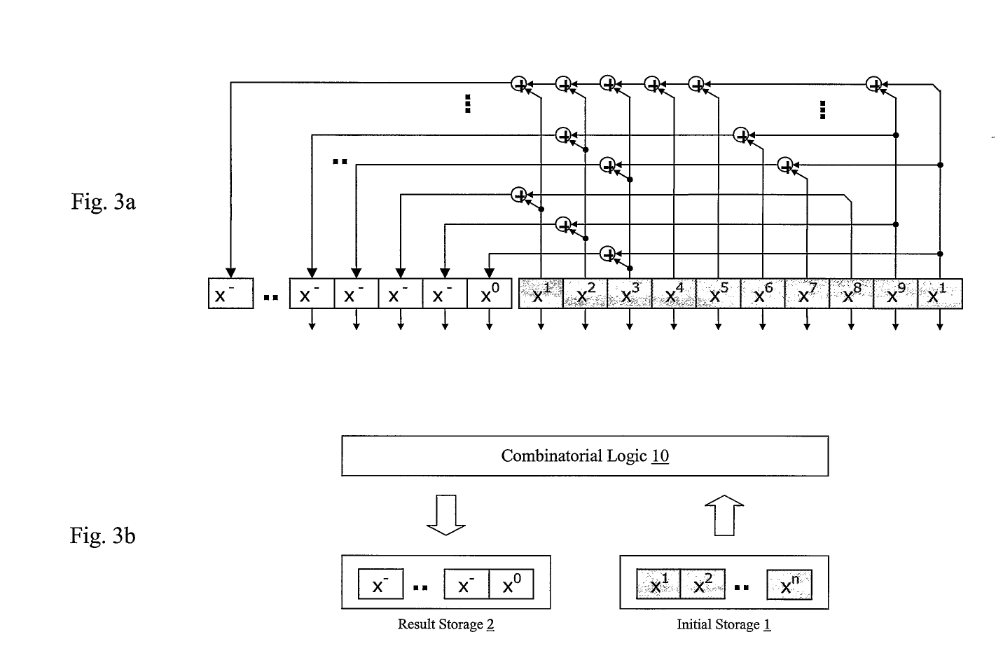

FIG. 3a shows a block diagram illustrating a logic diagram for generating simultaneously a number of n random bits according to an embodiment of the present invention;

FIG. 3b shows a block diagram illustration a schematic general block diagram of an input storage and output storage being linked together by a combinatorial logic for generating a pseudo random sequence according to an embodiment of the present invention;

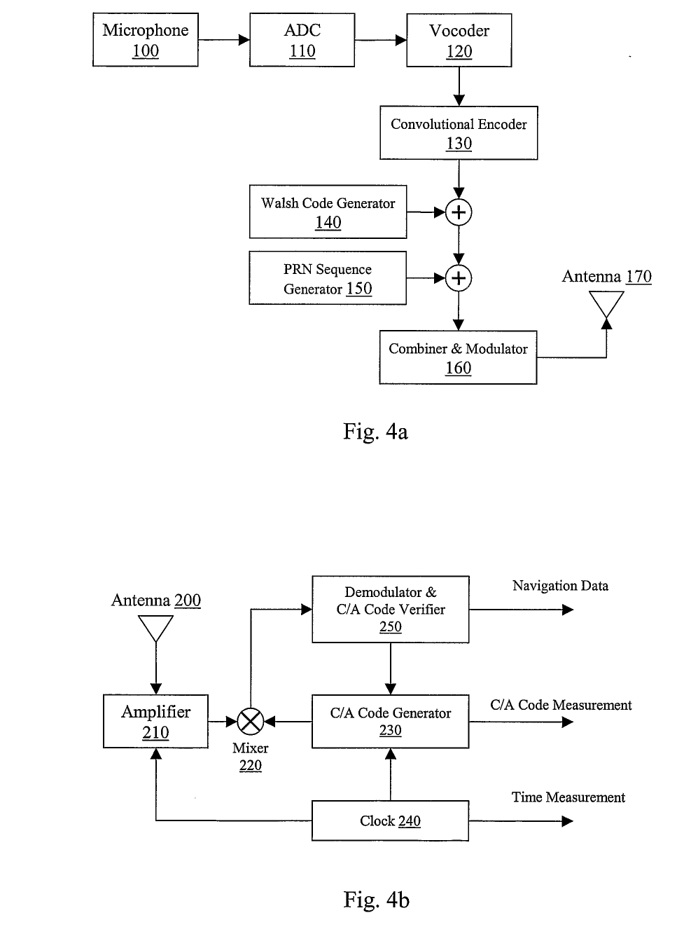

FIG. 4a illustrates schematically a block diagram of a base station CDMA transmitter and

FIG. 4b illustrates schematically a block diagram of a GPS receiver.

Reference will be made in detail to the embodiments of the invention examples, which are illustrated in the accompanying drawings. Wherever possible same reference numbers are used throughout drawings and description to refer to similar or like parts. The following description relates to various embodiments based on which the skilled reader will understand the principle inventive concept of the present invention. Nevertheless, the skilled reader will appreciate that the inventive concept is likewise applicable to further embodiments, which are covered by the scope of the accompanying claims.

The starting point of the description of the inventive concept shall be based on the known linear feedback shift register illustrated in FIG. 1b and described above in detail. For simplicity and for the way of illustration, the linear feedback function is given by combining the two tapped register elements x³ and x¹⁰ in accordance with the OR relationship, which is defined above by the means of a truth table. The following embodiment is based on this exemplary linear feedback function. It shall be noted that the present invention is not limited to this specific linear feedback function. However, based on the teaching, which will be given below with reference to this specific linear feedback function, a skilled reader will appreciate the inventive concept and will be able to generalize the teaching, which is applicable to numerous feedback functions implementable with shift registers in the aforementioned general manner. The scope of the invention is solely defined in the accompanying claims and not limited by any specific or particular embodiments of the detailed description.

The feedback function, illustrated in the logic diagram of FIG. 1b, can be denoted mathematically in form of a recursive polynomial, which is applied at each iterative cycle of the shift register. Assume that the shift register and its register elements are filled with original bit values or seed bit values, which serve as initial content for the generation of the pseudo random bit sequence in accordance with the feedback function such as described above with reference to FIG. 1b. Note that the stable state (i.e. all register elements are equal zero) has to be prevented. The mathematical denotation of the feedback function and original polynomial, respectively, can be written as

x³⊖¹⁰,

where the (bit) content of the third register element x³ and the (bit) content of the tenth register element x¹⁰ is combined by the OR relationship. Consequently, a new bit value x⁰, which represents the current result of the feedback function and which will become content of the first register element x¹ upon one clock cycle and iteration, respectively, can be predicted and can be calculated by the following polynomial:

x⁰=x³⊖x¹⁰.

It should be noted that in the following description reference to an order of the polynomials will be given. The order of the polynomial x⁰ as defined above results from the maximum order of the logically associated elements, herein the element x³ having the order 3 and the element x¹⁰ having the order 10. This means, an element xⁱ should have assigned an order i. In consequence to the definition above, the polynomial x⁰ has an order 10. It should be also noted that the number of elements, herein the ten elements x¹ to x¹⁰, typically corresponds to the order of the original polynomial due as further elements do not contribute to the feedback function and thus such further elements are needless.

Conclusively, further new/future bit values x⁻ⁱ, which represents the result of the feedback function after i clock cycles or iterations and which will become content of the first register element x¹ upon i+1 clock cycles or iterations, can be predicted and calculated in analogy. Exemplarily, the polynomial for the new bit values x⁻¹ and x⁻² can be written as:

x⁻¹=x²⊖x⁹, and

x⁻²=x¹⊖x⁸.

It should be noted that predicted new/future bit values x⁻ⁱ are denoted with a negative exponent including the exponent 0. The order of the corresponding polynomial for predicting the new/future bit values x⁻ⁱ should be defined on the basis of its elements. This means, the order of the polynomial x⁻¹ is equal to 9 and the order of the polynomial x⁻² is equal to 8.

Due to the shift register functionality, which shifts the content of the register elements xⁱ to the register elements xⁱ⁺¹ upon each clock cycle or iteration, the new (future) bit value x⁻¹ is obtainable from the register elements x² and x⁹, because x⁰ has to be calculated firstly and shifted into the shift register such that the contents of the register elements x² and x⁹ is present in the register elements x³ and x¹⁰ when x⁻¹ is to be calculated. Hence, one intermediate shift cycle has to be considered. The same argumentation applies to the calculation of the new (future) bit value x⁻², but there has to be considered two intermediate shift cycles.

Polynomials can be modeled in the aforementioned manner for each new (future) bit value x⁻ⁱ (i=1, 2, 3, . . . , n). An exemplary selection of polynomials is given below:

$${x}^{- 3} = {x}^{0} ⊕ {x}^{7} = ( {x}^{3} ⊕ {x}^{10} ) ⊕ {x}^{7} = {x}^{3} ⊕ {x}^{7} ⊕ {x}^{10} , \\ {x}^{- 4} = {x}^{- 1} ⊕ {x}^{6} = ( {x}^{2} ⊕ {x}^{9} ) ⊕ {x}^{6} = {x}^{2} ⊕ {x}^{6} ⊕ {x}^{9} , \\ {x}^{- 5} = {x}^{- 2} ⊕ {x}^{5} = ( {x}^{1} ⊕ {x}^{8} ) ⊕ {x}^{5} = {x}^{1} ⊕ {x}^{5} ⊕ {x}^{8} , \\ {x}^{- 6} = {x}^{- 3} ⊕ {x}^{4} = ( {x}^{3} ⊕ {x}^{7} ⊕ {x}^{10} ) ⊕ {x}^{4} = {x}^{3} ⊕ {x}^{4} ⊕ {x}^{7} ⊕ {x}^{10} , \\ {x}^{- 7} = {x}^{- 4} ⊕ {x}^{3} = … , \\ ⋮$$

$${x}^{- 33} = {x}^{- 30} ⊕ {x}^{- 23} = … = {x}^{1} ⊕ {x}^{2} ⊕ {x}^{3} ⊕ {x}^{4} ⊕ {x}^{5} ⊕ {x}^{9} ⊕ {x}^{10} , \\ ⋮ .$$

With reference to x⁻³, the polynomial defining the feedback value obtained after three intermediate shift cycles is determined of the values of the register element x⁰ and the register element x⁷. Skilled persons appreciate that the content/value of the register element x⁰ is unknown because the register element x⁰ is not part of the initial values. By including the above definition of the polynomial for x⁰, the polynomial x⁻³ can be reduced to a function of initial values and a function, which has an order within a range of orders from 1 to the order of the original polynomial. The skilled reader will appreciate on the basis of the exemplary selection of polynomials above that known polynomials of lower order (i.e. higher index −i) are included into polynomials of higher order (i.e. lower index −i) such that the polynomials defining the new (future) bit values x⁻ⁱ become functions equal or less than the order of the original polynomial, i.e. a function of the content/values of the register elements x¹ to x¹⁰ only.

The aforementioned exemplary selection of polynomials can be expanded to any number of desired polynomials serving as a sequence of polynomials to generate a pseudo random bit sequence of any number of bits. Such a pseudo random bit sequence may be interpreted as a random number having the corresponding bit length. Note that the aforementioned periodicity and number of differing states may have to be considered, respectively.

With reference to FIG. 2, an operation sequence block diagram enabling the generation of pseudo random bits and one or more pseudo random numbers (which pseudo random numbers are composed of the pseudo random bits) according to embodiments of the invention is depicted.

In an operation S100, the operational sequence starts. In accordance with the aforementioned description of the inventive concept, a number of m polynomials are provided in an operation S110, which polynomials are obtained from an original polynomial suitable for defining a feedback function of a feedback shift register as defined above. The polynomials are obtained in an operation successively applying the original polynomial and reducing the polynomials to functions which include orders in a range of one (“1”) to the maximal order of the original polynomial, which is herein ten in accordance with the order of the exemplary original polynomial. The polynomials may be statically defined or may be dynamically derived from the original polynomial. In case of statically defined polynomials, the polynomials are based on a pre-defined original polynomial, from which the polynomials have been derived, and may be provided directly or fixedly. In case of dynamical defined polynomials, the polynomials are derived from an original polynomial operable with a linear feedback shift register as a feedback function, which function or original polynomial is provided in an operation S111. The polynomials are derived form the original polynomial in an operation S112 in accordance with the basic inventive concept illustrated above on the basis of the exemplary polynomial.

In an operation S120, the initial values are provided. The provision of the initial values enables the application of the polynomials thereon, which results in an operation S130 in obtaining a sequence of pseudo random values, i.e. pseudo random bits, formed of the result values of each of the polynomials. Consequently in step S140, the obtained sequence of pseudo random bits can be supplied for further processing in step S141 requiring the sequence of pseudo random bits or a pseudo random number to be formed thereof. If no further processing is carried out the method comes to an end at step S150.

The application of the polynomials on the initial values may be performed in varying embodiments. With reference to an operation S121, the provided polynomials enable to essentially obtain simultaneously all pseudo random values from the polynomials, which realization of the essentially simultaneous obtainment may address a hardware implementation such as described exemplary with reference to FIG. 3a.

In contrast to operation S121, in an operation S122 an iterative application of the polynomials on the initial values can be performed. In order to illustrate the advantage of such an iterative process, reference shall be given to FIG. 1b, which illustrates a feedback shift register for generating a sequence of pseudo random values (bits). Assume that a sequence of pseudo random bits generated by the feedback shift register of FIG. 1b forms a pseudo random number having a most significant bit (MSB) and a least significant bit (LSB). Conventionally, the most significant bit is the first bit shifted to the output of the shift register, whereas the least significant bit is formed of the last bit shifted to the output of the shift register. Each sifting step corresponds to an iterative cycle of the shift register. Some applications, especially those described with reference to FIGS. 4a and 4b, accept a pseudo random number bitwise in sequence. But these applications assume to receive firstly the least significant bit (LSB) and lastly the most significant bit (MSB). With reference to the state of the art generating of pseudo random number by the means of a feedback shift register, all required iterative cycles have to be operated before the least significant bit is available, whereas the number of required cycles depend of the number of bits of the sequence of pseudo random bits, i.e. the length of the pseudo random number. It should be noted that the sequence of pseudo bits may comprise the initial values/bits or alternatively the initial values/bits are neglected.

With reference to the operation S122 according to an embodiment of the invention, the polynomials are applied in reverse order, which means that the least significant bit of the aforementioned sequence of pseudo random bits is obtainable firstly and the most significant bit of the aforementioned sequence of pseudo random bits is obtainable lastly. The sequence of the pseudo random bits is obtained in reverse order in comparison with the state of the art generation. The advantage of the reverse order obtainment of the sequence of the pseudo random bits, the generating procedure of the sequence of pseudo random bits and the further processing procedure, which requires the sequence of pseudo random bits for processing, can be interwoven or combined such that at each cycle a pseudo random bits is obtained and supplied to the further processing procedure, which processes the supplied pseudo random bit in the next cycle. Those skilled in the art will appreciate the possibility of interweaving the generation process according to an embodiment of the present invention, which results in a signification improvement of the total processing time.

FIG. 3a shows a block diagram, which illustrates a logic diagram for generating simultaneously a number of n random bits or a corresponding random number according to an embodiment of the present invention. The illustrated logic diagram including a plurality of OR logic elements or OR relationship operators can serve as a basis for realizing a corresponding logic circuit for instance forming a part of an application specific integrated circuit (ASIC). Alternatively, the logic circuit may be implemented by the means of a programmable logic component. The illustrated logic diagram including a plurality of OR relationship operators can alternatively serve as a basis for implementing a corresponding software-based method carrying out operations in accordance with the logic diagram. The logic diagram of FIG. 3a illustrates a selection of logical combination of the original bit values or seed bit values xⁱ with i=1, 2, . . . , 10, required for the illustratively depicted predicted (new/future) bit values x⁻ⁱ, i=0, 1, 2, 3, 4, . . . , 33. The seed bit values xⁱ with i=1, 2, . . . , 10 may be provided as valid signals or may be obtained by tapering storage cells storing the seed bit values xⁱ, i=1, 2, . . . , 10. The same applies to the predicted (new/future) bit values x⁻ⁱ, i=0, 1, 2, 3, 4, . . . , 33, which may be available as valid signals for further processing or which may be supplied to storage cells to be stored therein and provided to be read out allowing further processing thereof. The logic circuits reproduce the polynomials obtained by reduction to the order of the original polynomial described above. For instance with reference to x⁻³³, the storage cells, which stores the seed values x¹, x², x³, x⁴, x⁵, x⁹ and x¹⁰, are tapped from and supplied to OR logic elements in accordance with the polynomial x⁻³³.

The implementation of the logic diagram shown in FIG. 3a in form of an integrated circuit or as a program comprising code sections for performing the illustrated logic rules is part of the knowledge of those skilled in the specific art.

Conclusively, the inventive concept provides a methodology to parallelize at least partly the iterative and recursive pseudo random number generation being based on linear feedback shift registers. From mathematical view, the pseudo random number generation defined by one polynomial, which is applied iteratively and recursively on an initial sequence of bits (the seed bit sequence or seed number) in order to obtain pseudo random number comprising sequence of bits caused by the applied iterative and recursive methodology. The inventive concepts purposes to derive several polynomials from the one polynomial describing the feedback function, which polynomials are a function of the initial sequence of bits (the seed bit sequence or seed number) and which application results in the pseudo random number, which would be also obtainable by the aforementioned iterative and recursive methodology.

With reference to FIG. 3b, a generalized embodiment of the present invention is illustrated. Assuming a number of n bits forming the initial sequence of bits (the seed bit sequence or seed number) depicted as initial storage 1, the resulting total random number can comprise a maximum of 2^{np}−1 bits before repetition of the bit sequence occurs, wherein np denotes the order of the original polynomial. Consequently, 2^{np}−(n+1) (10 bits are seed or initial bits) static polynomials can be derived in accordance with the methodology proposed above. Hence, the result storage 2 illustrated in FIG. 3b comprises m one-bit storage cells; the maximum mₘₐₓ of cells is equal to the maximum of derivable polynomials; i.e. mₘₐₓ=2^{np}−(n+1). Applying these general remarks to the embodiment shown in FIG. 3a, the initial bit sequence comprises n=10 bits in correspondence with the order of the original polynomial. This means, 2¹⁰−11=1013 static polynomials can be derived and can be calculated parallel to obtain the complete sequence of 1023 bits (comprising the ten initial bits). As aforementioned, the combinatorial logic 10 of FIG. 3b can be implemented as a hardware combinatorial logic or as a software module comprising combinatorial logic relationships in accordance with the polynomials defined above.

The application of the aforementioned polynomials to obtain pseudo random numbers enables to generate the pseudo random numbers in reverse order in comparison with the iterative and recursive method. Firstly, lower bits of the pseudo random numbers can be obtained and subsequently higher bits of the pseudo random numbers are gained.

The integration of a combinatorial logic within an integrated circuit as exemplary illustrated in FIG. 3a enables to simultaneously obtain a sequence of bits for forming a pseudo random number comprising this sequence and eventually the initial sequence of bits (i.e. the seed bits). The integrated circuit comprises for instance a number of n storage cells each capable for storing a one-bit value. The n storage cells serve to store the initial bit values or seed values, which n storage cells are represented exemplarily in FIG. 3a by the cells x¹ to x¹⁰. The integrated circuit comprises additionally for instance a number of m storage cells each also capable for storing a one-bit value, which m storage cells are represented exemplarily in FIG. 3a by the cells x⁰ to x⁻³³. Each input of the m storage cells is coupled to a combinatorial logic in accordance with the polynomials described above. Each combinatorial logic receives its input values from output terminals of the corresponding selection of the n storage cells defined by the corresponding polynomial.

With reference to the embodiment illustrated in FIG. 3a, the value of the cell x⁰ is determined by the values of the cells x³ and x¹⁰, which values are combined by a OR logic relationship or OR logic component. The cell x⁻³³ is defined by the values of the cell x¹⁰, x⁹, x⁵, x⁴, x³, x², and x¹, which are each combined by OR logic relationship or OR logic component. Corresponding combinatorial logics are obtained from the further polynomials. Those skilled in the art will appreciate that the maximal number mₘₐₓ of storage cells is equal to the maximal number of derivable polynomials, which is equal to 2ⁿ−(n+1) as defined above. In case the number of m storage cells is smaller that the maximal number mₘₐₓ, the cell values of the lower cells, i.e. the cells having the lower indices, may be used as initial values and seed values, respectively. Hence, the maximal sequence of bits can be always obtained even when implementing a limited number of storage cells and combinatorial logic elements.

Those skilled in the art will appreciate that the embodiments illustrated in FIGS. 3a and 3b and described with reference thereto may be modified. In particular, the aforementioned embodiments include storage cells to store the initial (seed) values and the result values caused by the combinatorial logic. A modification of these embodiments may manage the inventive concept without storage cells. This means, an alternative (modified) embodiment comprises a combinatorial logic as described above, which is supplied with a number of n signals and states, respectively, representing the initial (seed) values and being used as such. Consequently, the combinatorial logic causes a number of m signals and states, respectively, which represent the result values caused by the combinatorial logic fed with the initial states.

As briefly mentioned in the introduction to this invention, pseudo random numbers are widely applied. In particular, GPS receivers and CDMA transmission technology make extensive use of pseudo random numbers.

FIGS. 4a and 4b illustrate schematically block diagrams of a base station CDMA transmitter and a GPS receiver, which both take use of pseudo random number generators for operation.

With reference to FIG. 4a, each voice conversation is converted into digital code (with the help of an analog-to-digital converter ADC 110) and encoded by the means of a voice encoder or vocoder 120. The vocoder output is supplied to a convolutional encoder 130 that adds redundancy for error correction and each bit is replicated 64 times (not shown). Further, the resulting bit sequence is OR-ed with a Walsh code provided by a Walsh code generator 140, which Walsh code is used to identify that call from the rest and output of the OR-ed bit sequence is again OR-ed with a string of pseudo random bits from a pseudo random generator 150, which string of bits is used to identify all the calls within a particular cell sector. All the calls at the base station are combined and modulated onto a carrier frequency at a combiner and modulator 160 and transmitted via the antenna 170 to the mobile stations. At a receiving mobile station, the received signals are quantized and fed through a Walsh code and pseudo random number sequence correlation receiver to reconstruct the transmitted bits of the original signals dedicated to the corresponding mobile station.

With reference to FIG. 4b, a GPS signal on the L1 (1575.42 MHz) or GPS signals on the L1 and L2 (1227.60 MHz) carrier frequencies is received via the antenna 200 and supplied to an amplifier 210. The GPS signal on the L2 carrier frequency is conventionally scrambled and dedicated for exclusive military use. The GPS signal carried on the L1 carrier frequency is known as a coarse acquisition signal and is composed of a 1.023 MHz pseudo random sequence signal and a 50 Hz navigation and system data signal both modulated onto the L1 carrier frequency.

The 1 MHz pseudo random sequence signal is used for determining the time of flight of the GPS signal emitted by a GPS satellite and received by the GPS receiver. The GPS receiver is informed about the seed value used by the GPS satellite for generating the 1.023 MHz pseudo random sequence signal. The C/A code generator represents a pseudo random number generator 230 by the means of which the GPS receiver generates the same pseudo random sequence signal employing the known seed value. Due to the finite time of flight of the GPS signal the received pseudo random sequence signal and the generated pseudo random sequence signal differ about a phase shift in relation to each other. The phase shift can be determined in form of a code of chip shift such that a pseudo range can be obtained, which approximates the distance between GPS satellite and GPS receiver.

Both examples, i.e. the CDMA transmitter as well as the GPS receiver, use pseudo random generators for operation. In case of the CDMA transmitter, the generation rate required for the employed pseudo random generator is defined by the data rate of the bit sequence to be OR-ed with the pseudo random sequence. In case of the GPS receiver, the generation rate required for the employed pseudo random generator is defined by the pseudo random sequence signal generated and emitted by the GPS satellite. Those skilled in the art will appreciate that these two examples illustrate only two of many applications, which require fast and economical pseudo random generators. Especially, increasing data rates in mobile data communication technologies employing CDMA technology drives the requirement for such fast and economical pseudo random generators, which can be realized on the basis of the inventive concept illustrated in detail above in view of an embodiment.

Even though the invention is described above with reference to embodiments according to the accompanying drawings, it is clear that the invention is not restricted thereto but it can be modified in several ways within the scope of the appended claims.

1. Method for generating a pseudo random number, comprising:
providing a plurality of m polynomials, wherein said polynomials are derived from an original polynomial defining a feedback function of a linear feedback shift register, wherein said polynomials are functions of n bits serving as initial bits;
applying said polynomials on said initial bits for generating said pseudo random number comprising at least m bits resulting from said polynomials.

2. Method according to claim 1, comprising:
deriving said plurality of m polynomials from said original polynomial by
stepwise defining polynomials representing said feedback function at each iteration; and
reducing said polynomials to obtain polynomials being functions of said initial bits.

3. Method according to claim 1 or 2, comprising:
applying said polynomials substantially simultaneously.

4. Method according to claim 1 or 2, comprising:
applying said polynomials in reverse order to generate firstly lower bits of said pseudo random number and subsequently higher bits of said pseudo random number.

5. Method according to anyone of the preceding claims, wherein said polynomials represent logic relationships for combining at least two values each having a domain of one bit.

6. Method according to anyone of the claims 1 to 5, wherein said m polynomials are static polynomials, which can be provided fixedly.

7. Method according to anyone of the claims 1 to 5, wherein said m polynomials are dynamic polynomials, which are obtainable from said original polynomial by reduction of the orders of said polynomials equal or less than an order of said original polynomial.

8. Method according to anyone of the preceding claims, wherein said maximal number mₘₐₓ of said polynomials is less or equal to 2^{np}−(n+1), where np represents the order of the original polynomial.

9. Method according to anyone of the preceding claims, wherein an order of said polynomials is equal or less to np, wherein np represents the order of the original polynomial.

10. Method according to anyone of the preceding claims, wherein said pseudo random number comprising said m bits resulting from said polynomials and said n initial bits is identical with a sequence obtained from a linear feedback shift register used as a pseudo random number generator and applying a feedback function corresponding to said original polynomial.

11. Module for generating a pseudo random number, comprising:
a number of n initial storage cells each serving as a one-bit storage;
a number of m result storage cells each serving as a one-bit storage; and
a combinatorial logic being selectively coupled to output terminals of said n initial storage cells and being selectively coupled to input terminals of said m result storage cells, wherein said combinatorial logic implements a number of m polynomials, wherein said polynomials are derived from an original polynomial defining a feedback function of a linear feedback shift register, wherein said polynomials are functions of n bits serving as initial bits.

12. Module according to claim 11, wherein said combinatorial logic is implemented as a software module comprising code sections, which when executed on a processing unit perform logical relationship operations in accordance with said combinatorial logic.

13. Module according to claim 11, wherein said combinatorial logic is implemented by the means of a plurality of logic components, each having at least two input terminals for receiving one-bit inputs and each having at least one output terminal for providing a one-bit output, which output is defined by a predefined combinatorial logic relationship.

14. Electronic apparatus enabled for generating a pseudo random number, comprising at least a module for generating a pseudo random number, said module comprising:
a number of n initial storage cells each serving as a one-bit storage;
a number of m result storage cells each serving as a one-bit storage; and
a combinatorial logic being selectively coupled to output terminals of said n initial storage cells and being selectively coupled to input terminals of said m result storage cells, wherein said combinatorial logic implements a number of m polynomials, wherein said polynomials are derived from an original polynomial defining a feedback function of a linear feedback shift register, wherein said polynomials are functions of n bits serving as initial bits.

15. System for generating a pseudo random number, comprising:
a number of n initial states representing n initial 1-bit values;
a number of m result states representing m result 1-bit values; and
a combinatorial logic being selectively supplied with said n initial states and supplying selectively said m result states, wherein said combinatorial logic implements a number of m polynomials, wherein said polynomials are derived from an original polynomial defining a feedback function of a linear feedback shift register, wherein said polynomials are functions of n 1-bit states serving as initial states.

16. Computer program product for generating a pseudo random number, comprising program code sections for carrying out the steps of anyone of claims 1 to 10, when said program is run on a processor-based device, a terminal device, a network device, a portable terminal, a consumer electronic device, or a mobile communication enabled terminal.

17. Computer program product for generating a pseudo random number, comprising program code sections stored on a machine-readable medium for carrying out the steps of anyone of claims 1 to 10, when said program product is run on a processor-based device, a terminal device, a network device, a portable terminal, a consumer electronic device, or a mobile communication enabled terminal.

18. Software tool for generating a pseudo random number, comprising program portions for carrying out the operations of any one of the claims 1 to 10, when said program is implemented in a computer program for being executed on a processor-based device, a terminal device, a network device, a portable terminal, a consumer electronic device, or a mobile communication enabled terminal.

19. Computer data signal embodied in a carrier wave and representing instructions, which when executed by a processor cause the steps of anyone of claims 1 to 10 to be carried out.
